(19) United States
(12) Patent Application Publication
(10) Pub. No.: US 2017/0269691 A1
(43) Pub. Date: Sep. 21, 2017

(54) HAPTIC METHOD AND DEVICE TO CAPTURE AND RENDER SLIDING FRICTION

(71) Applicant: THOMSON LICENSING, Issy les Moulineaux (FR)

(72) Inventors: Julien FLEUREAU, RENNES (FR); Olivier DUMAS, LA MEZIERE (FR); Fabien DANIEAU, RENNES (FR); Philippe GUILLOTEL, Vern sur Seiche (FR)

(73) Assignee: Thomson Licensing, Issy les Moulineaux (FR)

(21) Appl. No.: 15/532,099

(22) PCT Filed: Nov. 25, 2015
(86) PCT No.: PCT/EP2015/077613

§ 371 Date: Jun. 1, 2017

(30) Foreign Application Priority Data
Dec. 2, 2014 (EP) 14306935.9

(51) Int. Cl. G06F 3/01; G01N 19/02; G01B 5/28; G06F 3/0354; G06F 3/16

(52) U.S. Cl. CPC G06F 3/016; G06F 3/03545; G06F 3/16; G01B 5/28; G01N 19/02

(57) ABSTRACT

The invention relates to a device configured to determine and/or render information representative of roughness of a first surface of an object, the device comprising means for measuring a first pressure applied by at least a part of a hand on said device, sticky means configured to be in contact with the first surface and means for measuring a speed of the device.

### 1. TECHNICAL FIELD

The present disclosure relates to the domain of haptic. More specifically, the present disclosure relates to a method and device to capture and render sliding friction (also known as roughness) of a surface of an object through a tangible interface.

### 2. BACKGROUND ART

According to the background art, it is known to use haptic interfaces, which allow a user to touch virtual and remote environments trough a hand-held device, in applications such as computer-aided design and robot-assisted surgery. Unfortunately, the haptic renderings produced by these systems seldom feel like realistic rendering of the varied surfaces one encounters in the real world.

### 3. SUMMARY

The purpose of the present disclosure is to overcome at least one of these disadvantages of the background art.

More specifically, one purpose of the present disclosure is to determine information representative of a surface and/or to render such an information representative of roughness.

The present disclosure relates to a device configured to determine information representative of roughness of a surface of an object. The device advantageously comprises:
means for measuring a first pressure applied by at least a part of a hand on the device,
sticky means configured to be in contact with the surface,
means for measuring a speed of the device.

According to a particular characteristic, the device further comprises means for measuring a second pressure applied on the sticky means.

Advantageously, the device further comprises means for acquiring information representative of a sound made by the device when moving on the surface.

According to a specific characteristic, the device further comprises means for measuring information representative of thermal properties of the surface.

Advantageously, the device further comprises means for storing information representative of the first pressure and information representative of the speed.

According to a particular characteristic, the device further comprises a communication interface configured to transmit information representative of the first pressure and information representative of the speed.

According to a specific characteristic, the device is a hand-held device, the means for measuring the first pressure being arranged on a part of a body of the device.

The present disclosure relates to a device configured to render information representative of roughness of a first surface of an object, the device comprising:
means for measuring a first pressure applied by at least a part of a hand on the device,
means for measuring a speed of the device,
means for adapting roughness of a part of the device configured to be in contact with a second surface different from the first surface, the roughness of the part of the device being adapted according to the measured first pressure, the measured speed and according to information representative of the feel of the first surface to be rendered.

Advantageously, the device further comprises vibratory means configured to render vibratory effect.

According to a specific characteristic, the device further comprises means for rendering thermal properties of the first surface.

According to another characteristic, the device further comprises means for rendering at least a sound.

Advantageously, the device is a hand-held device, the means for measuring the first pressure being arranged on a part of a body of the device.

According to a specific characteristic, the device is comprised in a haptic device.

The present disclosure also relates to a method of determining information representative of roughness of a surface of an object with an hand-held device, the method comprising:
measuring a pressure applied by at least a part of a hand on the hand-held device during a motion of the hand-held device on said surface, the hand-held device being in contact with the surface during the motion,
measuring a speed of the hand-held device during the motion of the hand-held device on the surface,
generating the information representative of roughness of the surface according to the measured first pressure and the measured speed.

The present disclosure also relates to a method of rendering information representative of roughness of a first surface of an object with an hand-held device, the method comprising:
measuring a first pressure applied by at least a part of a hand on the hand-held device during a motion of the hand-held device on a second surface different from the first surface, the hand-held device being in contact with the second surface during the motion,
measuring a speed of the hand-held device during the motion of the hand-held device on the second surface,
adapting roughness of the part of the hand-held device in contact with the second surface, the roughness of the part of the device being adapted according to the measured first pressure, the measured speed and according to information representative of the feel of the first surface to be rendered.

### 4. LIST OF FIGURES

The present disclosure will be better understood, and other specific features and advantages will emerge upon reading the following description, the description making reference to the annexed drawings wherein:

FIG. 1 shows a device configured to capture and render the roughness of a surface of an object, according to a particular embodiment of the present principles;

FIG. 2 shows details of the capturing part of the device of FIG. 1, according to a particular embodiment of the present principles;

FIG. 3 shows details of the rendering part of the device of FIG. 1, according to a particular embodiment of the present principles;

FIG. 4 shows operations for capturing and rendering operations the roughness of the surface through the use of the device of FIG. 1, according to a particular embodiment of the present principles;

FIG. 5 shows the capture of the roughness of the surface with the use of the device of FIG. 1, according to a particular embodiment of the present principles;

FIG. 6 shows the rendering of the roughness of the surface of FIG. 5 with the use of the device of FIG. 1, according to a particular embodiment of the present principles;

FIG. 7 shows a method of determining information representative of the roughness of a surface of an object implemented by using the device of FIG. 1, according to a particular embodiment of the present principles;

FIG. 8 shows a method of rendering information representative of the roughness of a surface of an object implemented by using the device of FIG. 1, according to a particular embodiment of the present principles;

FIG. 9 shows two examples of roughness models associated of a surface, according to a particular embodiment of the present principles.

### 5. DETAILED DESCRIPTION OF EMBODIMENTS

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details.

The present disclosure will be described in reference to a particular embodiment of a device configured to determine the state of a surface of any object of the real world, i.e. configured to determine an information representative of the roughness (also known as sliding friction) of a first surface. The device advantageously comprises means for measuring the pressure applied by a hand or part of the hand on said device when acquiring the information representative of the roughness of the first surface, the means corresponding for example to a pressure sensitive surface arranged on the device at a location where a user grips the device. The device also comprises sticky means arranged on a part of the device, for example at an extremity of the device, the sticky means being adapted to be in contact with the first surface when acquiring the information representative of roughness of the first surface. The device also comprises means for measuring the speed of the device when the device is moved over the first surface to acquire the information representative of roughness of the first surface.

The present disclosure will also be described in reference to a particular embodiment of a device configured to render the state or feel of a first surface of an object of the real world, i.e. a device configured to render an information representative of the roughness of the first surface. The device advantageously comprises means for measuring the pressure applied by a hand or part of the hand on said device when rendering the roughness of the first surface, the means corresponding for example to a pressure sensitive surface arranged on the device at a location where a user grips the device. The device also comprises means for measuring the speed of the device when the device is moved over the surface to acquire the roughness of the surface. The device also comprises means for adapting the roughness of a part of the device, for example an extremity of the device, configured to be in contact with a second surface during the motion of the device over the second surface to render the roughness of the first surface. The second surface is advantageously different from the first surface, which enables to render the roughness of a surface of another surface, thus enabling to have the feeling of the texture of the first surface but on the second surface. The roughness of the part of the device is advantageously adapted according to the measured pressure applied on the device, the measured speed of the device during motion over the second surface and according to information representative of the roughness of the first surface, acquired for example with the aforementioned device configured to measure the roughness of a surface of an object.

It is understood with roughness of a surface a component of the texture of the surface that may be quantified by the vertical deviations (or irregularities) of a real surface from its ideal form. If these deviations are large, the surface is rough and if these deviations are small, the surface is smooth. Roughness advantageously corresponds to the high-frequency, short-wavelength surface deviations (peaks and values) of a measured surface. Rough surface have higher friction coefficients than smooth surface. Ra is the most commonly used surface roughness definition and is expressed mathematically by

Rₐ=1/nΣᵢ₌₁ⁿ|yᵢ| equation 1

where n is the total number of data points used in the calculation and Y is the vertical surface position measure from the average surface height.

An example of an information representative of the roughness of a surface is the sliding friction, which corresponds to the friction generated by the contact of two surfaces in contact move relative to each other. The friction corresponds to the conversion of the kinetic energy (associated with the motion) into thermal energy.

The friction of the first surface may be obtained from the pressure applied by the hand of a user on the pressure sensitive surface, or the like, and from the speed of the motion of the device on the surface, the sticky means generating an opposition strength to the motion of the device on the surface. The combination of means for measuring the pressure applied, means for measuring the speed of the device and of sticky means enable to obtain all data needed to obtain the friction coefficients associated with a surface, for example along the path corresponding to the sliding motion of the device on the surface. Indeed, at a given speed, the more pressure is applied by the user on the device, the highest the friction associated with the surface is.

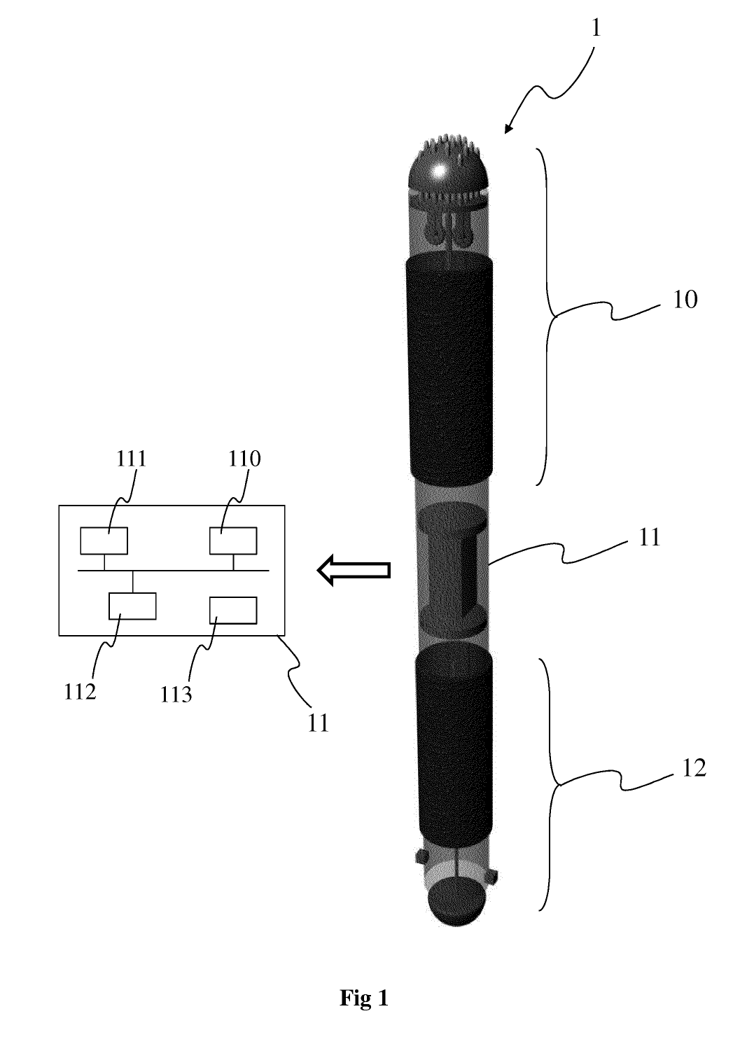

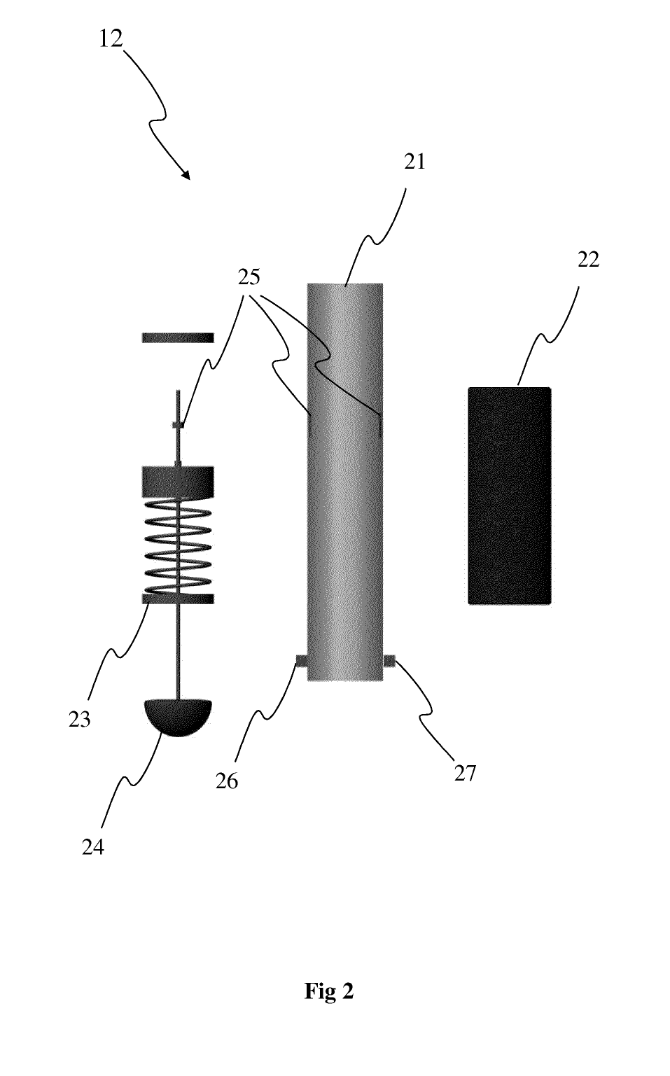

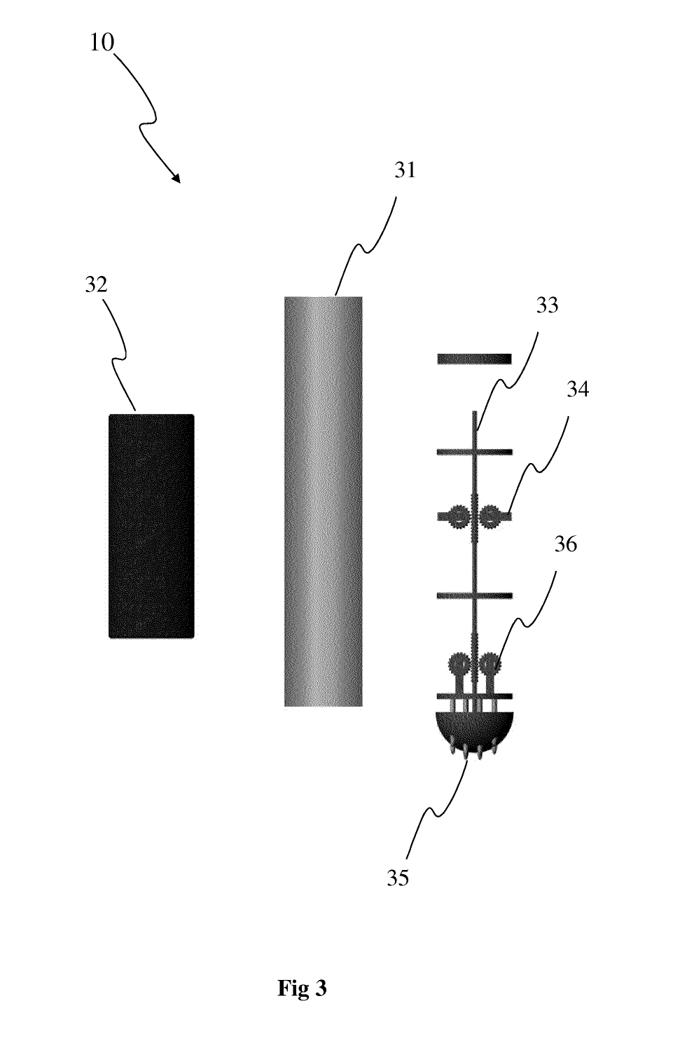

FIG. 1 shows a device 1 having the general form of a pen, the device 1 being configured to capture and render the roughness of any surface of any object, according to an exemplary and non-limiting embodiment of the present principles. The device 1 comprises both roughness rendering module 10 and roughness capturing module 12. Device 1 may be referred as “haptic pen”. An exemplary embodiment of the rendering module 10 is described with more detail with regard to FIG. 3 and an exemplary embodiment of the capturing module 12 is described with more details with regard to FIG. 2. The device 1 also comprises a processing module 11 configured to process data coming from the capturing module 12 and/or to process data coming from and/or intended to the rendering module 10.

The processing module 11 advantageously corresponds to a hardware module configured to process data coming from or intended to one or both modules 10 and 12. The processing module 11 advantageously comprises a processing unit 110, i.e. for example one or several processors associated with a memory 111, for example Random Access Memory or RAM 2032 comprising registers. The memory may be used to store data acquired with the capture part 12, for example the speed of the device when moving during a capturing stage of information representative of the roughness of the surface, the pressure applied by a user holding the device during the capturing stage of information representative of the roughness of the surface, and/or information representative of the roughness of the surface captured with the device 1. The memory may also be used to store data coming from the rendering module 10, such as for example the speed of the device when moving during a rendering stage of information representative of the roughness of the surface, the pressure applied by a user holding the device during the rendering stage of information representative of the roughness of the surface. Data stored within the memory 111 are advantageously processed by the processing unit 110. The memory 111 may also be used to store instructions of an algorithm implementing the method of capturing and/or rendering information representative of the roughness of a surface. According to a non-limiting example, the module 11 may also comprise a communication interface configured to transmit and/or receive the data stored in the memory to a remote processing unit. The communication interface is for example a wireless communication interface, for example compliant with Bluetooth, Zygbee and/or Wi-Fi. The module 11 may also comprise a battery 113. According to a variant, the module takes the form of a programmable logical circuit of type FPGA (Field-Programmable Gate Array) for example, ASIC (Application-Specific Integrated Circuit) or a DSP (Digital Signal Processor).

According to a variant, the rendering module 10 and the capturing module 12 are not integrated into a single device 1 but form two separate devices. According to this variant, each module 10 and 12 comprises its own processing unit.

Naturally, the general form of the device 1 is not limited to a pen but extends to any form, for example to the form of a mouse.

FIG. 2 shows details of the capturing module 12 of the device 1, according to an exemplary and non-limiting embodiment of the present principles. The capturing module 12 comprises a pressure sensitive surface 22 that may be arranged on the body 21 of the device, for example at a location where a user grips the capturing module 12 with a hand. The capturing module 12 also comprises a slightly sticky lead 24 arranged on a part of the capturing module 12 adapted to be in contact with a first surface for which the information of roughness is to be determined. The capturing module 12 also comprises a system, for example motion sensors 25, enabling the tracking of the capturing module speed. At a given speed, the higher the sliding friction between the lead and the first surface, the stronger the user holding the capturing module 12 will have to press on the body part of the capturing module 12.

The sticky lead 24 is advantageously attached to a mobile vertical axis 23 which motion (when the capturing module 12/device 1 is sliding on the first surface) is captured by motion sensors 25 (a combination of a magnetic sensor and an accelerometer for instance). The sticky lead 24 is able to reproduce the kind of contact that a finger would have with the texture of the first surface and the motion sensors are able to capture both relief variations (waviness) and vibrations inferred by the sliding on the surface. The induced friction is captured by the means of the pressure surface sensor 22. At a given speed, the more sticky the first surface is, the more the user holding the capturing module 12 will have to press the grasped area of the capturing module 12. Optionally a complementary friction information may be captured by the motion sensor 25 as one can expect a user to force more on the sticky lead 24 when the sliding on the first surface becomes harder.

According to an optional variant, the capturing module 12 comprises a miniaturized microphone 27 configured to capture the typical sound that is induced by the friction between the sticky lead and the first surface.

According to another variant, the capturing module 12 comprises a thermal sensor (a combination of an infra-red emitter and an infra-red sensor for instance) configured to acquire the thermal properties of the material of the first surface (a metal surface would be felt as colder than a tissue for instance).

FIG. 3 shows details of the rendering module 10 of the device 1, according to an exemplary and non-limiting embodiment of the present principles. The rendering module 10 comprises a pressure sensitive surface 32 (for example identical or similar to the pressure sensitive surface 22) that may be arranged on the body 31 of the rendering module 10, for example at a location where a user grips the rendering module 10 with a hand. The rendering module 10 also comprises a lead 35 which roughness can be dynamically adapted and a system enabling the tracking of the speed of the rendering module 10, for example the same system as the one comprised in the capturing module 12. The rendering of the sliding effect, i.e. the sliding friction captured by sliding the capturing module 12 on the first surface, is performed by the mean of a closed-loop which continuously adapt the roughness of the lead 35 regarding the sliding speed of the rendering module 10 and the distance between the current friction level (estimated from the pressure pattern, derived from the pressure sensitive surface 32, at the current speed) and the friction level used as input, i.e. the friction level of the first surface to be rendered.

The pressure pattern provides for example with information representative of the location of the pressure strength(s) applied on the pressure sensitive surface, in addition to the strength values themselves. When several pressure intensities are measured over the pressure sensitive surface, the mean value of the measured pressure intensities may be for example used to calculate the information representative of roughness.

The roughness of the lead 35 is advantageously adapted by means of a slippery head with retractable sticky picots provided with the lead 35. The retractable sticky picots may advantageously move (by the mean of dedicated actuators) along a vertical axis 33 with force-feedback capabilities. The vertical may also independently move along the body 31 by means of dedicated actuators 34. The role of the slippery head with retractable sticky picots 35 is to induce gradable friction effects. To that end, the associated actuators 36 can gradually push a matrix of picots through the head so that when they are totally retracted a slippery behavior is reproduced and as soon as the picots are pushed, a sticky material is alternatively imitated. At the same time, the pressure sensor surface 32 is able to capture the level of roughness in a similar way that the one used during the capture stage. The role of the vertical axis 33 is to reproduce both relief variations and vibrations (waviness) that have been captured on the first surface during the capture stage.

According to a variant, the rendering module 10 comprises a vibrator to render the specific vibratory effects.

According to another variant, the rendering module 10 comprises a thermal actuator, which is for example associated with the pressure sensitive surface 32, to reproduce the thermal properties of the captured texture of the first surface or to enhance the friction effect sensation by providing more or less heat.

According to a further variant, the rendering module 10 comprises an audio speaker to render the sound acquired during the capturing stage of the roughness of the first surface.

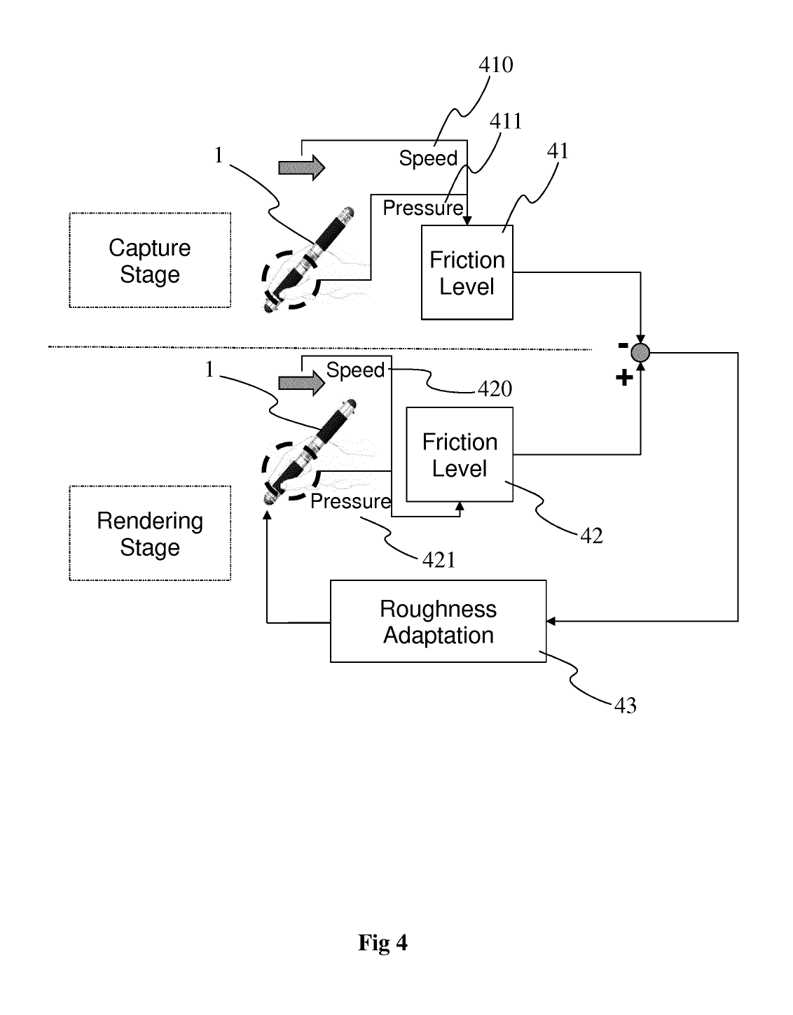

FIG. 4 shows processes involved in the capture and rendering of an information representative of the roughness of a first surface, according to an exemplary and non-limiting embodiment of the present principles.

At the capturing stage, a user grips the device 1 with a hand and slides the device 1 on the first surface, the capturing module of the device 1 being in contact with the first surface during the sliding. The speed of the device 1 is measured during the sliding motion of the device 1. Speed values 410 are for example measured at a rate of 5000 Hz or 10000 Hz. At the same time, information 411 representative of the pressure applied by the hand of the user on the device 1 is measured, advantageously at the same rate than the measuring rate of the speed. Information representative of the pressure correspond for example to pressure intensities applied by the hand and/or to the pressure pattern applied on the device 1. Information 41 representative of the roughness of the first surface is calculated from the speed values 410 and the information 411 representative of the pressure. The information 41 representative of the roughness corresponds for example to the different friction levels of the surface along the sliding motion of the device over the first surface.

At the rendering stage, the user grips the device 1 with a hand and slides the device 1 on a second surface, the rendering module of the device 1 being in contact with the second surface during the sliding. The second surface is advantageously different from the first surface and one aim of the rendering stage is to render the information representative of the roughness of the first surface but on the second surface, giving the illusion that the texture of the second surface is the same as the texture of the first surface, or at least that the roughness of the second surface is the same as the roughness of the first surface. The speed of the device 1 is measured during the sliding motion of the device 1 on the second surface. Speed values 420 are for example measured at a rate of 5000 Hz or 10000 Hz. At the same time, information 421 representative of the pressure applied by the hand of the user on the device 1 is measured, advantageously at the same rate than the measuring rate of the speed. Information representative of the pressure correspond for example to pressure intensities applied by the hand and/or to the pressure pattern applied on the device 1. Information 42 representative of the roughness of the second surface is calculated from the speed values 420 and the information 421 representative of the pressure. The information 42 representative of the roughness corresponds for example to the different friction levels of the second surface along the sliding motion of the device over the second surface. Differences between the information 42 and the information 41 enables to compute parameters 43 for controlling the roughness of the part of the device 1 in contact with the second surface when rendering the information representative of the roughness of the first surface, as described with regard to FIG. 3.

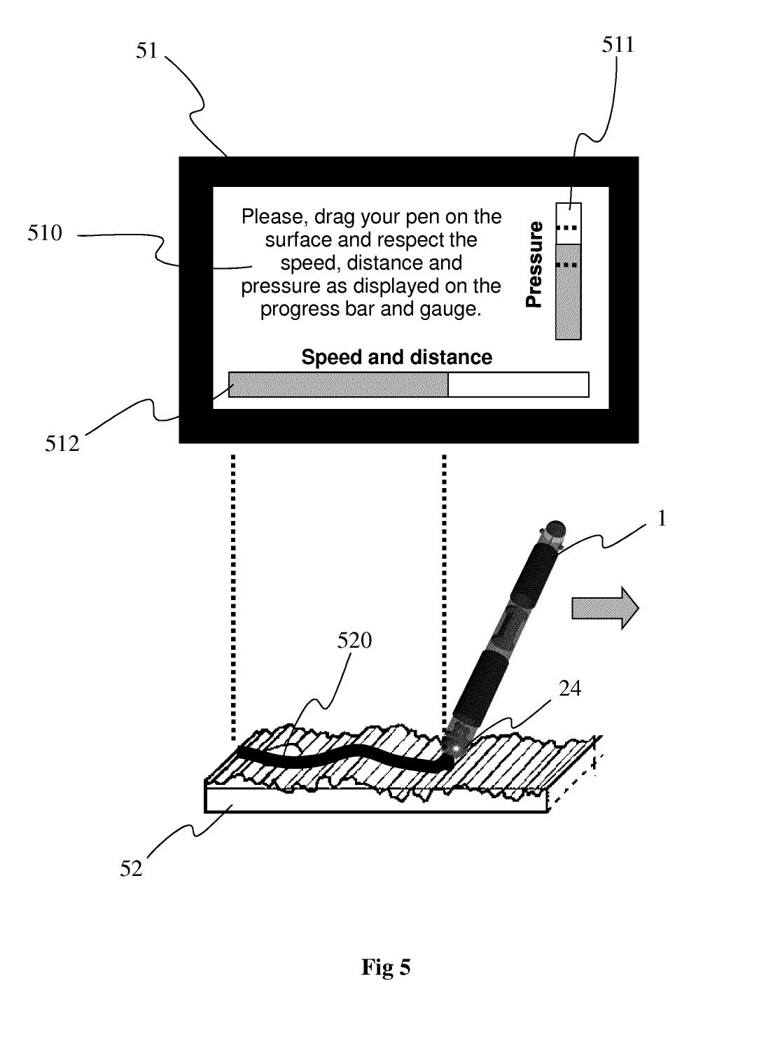

FIG. 5 shows the capturing stage of the information representative of the roughness of the first surface 52 with the use of the device 1, according to an exemplary and non-limiting embodiment of the present principles. The capturing stage is advantageously performed by sliding the device 1 on the first surface 52, the capturing part of the device 1 being directed toward the first surface with the sticky lead 24 in contact with the first surface 52 during the sliding of the device 1 on the first surface. The device according to claim 1, further comprising means (23) for measuring a the sticky lead 24 on the first surface 52 is illustrated with a line 520. Various protocols may be envisioned to capture the information representative of the roughness of the first surface 52, for example the sliding friction along the path 520. The user capturing the information representative of roughness of the first surface 52 may be advantageously guided with a user interface, displayed for example on a screen, for example the screen of a tablet 51. Instruction asking to slip the device 1 on the first surface at a given speed and for a given pressure on the device lead 24 (measured thanks to its force-feedback capabilities) are advantageously displayed on a first part 510 of the screen of the tablet 51. Indication about the speed and distance is advantageously displayed on a second part 512 of the screen of the tablet 51. Indication about the pressure applied on the sticky lead 24 is advantageously displayed on a third part of the screen of the tablet 51. This visual information helps the user in capturing the roughness of the first surface 52 by giving useful indications on the control of the device 1 with use parameters adapted to obtain good values representative of the roughness.

According to a variant, the sliding speed of the device 1 may be controlled by the mean of an additional accelerometer or any tracking solution external to the device 1.

According to another variant, the sliding procedure may be repeated in an orthogonal direction to the path 520 to capture the texture lay (for anisotropic textures) of the first surface 52.

In the end, one has been able to record the pressure variations on the pressure sensitive component of the device 1 with a controlled speed and a friction measurement may be inferred. According to an embodiment, the friction may be computed as a combination of the pressure applied by the hand of the user on the device 1 normalized by the sliding speed, making use of mechanical models of the device 1 and of the scanned material (i.e. the first surface) to establish the precise relation.

FIG. 9 shows two models of the roughness that may be obtained at the end of the acquisition process described with regard to FIG. 5, according to an exemplary and non-limiting embodiment of the present principles. The roughness properties of the first surface are advantageously modeled as a function (e.g. according to the Coulomb model) relating the speed v of the device 1 and the pressure intensity p measured on the pressure-sensitive surface. This relation may be for instance modeled by polynomial functions and the coefficients of the polynom may play the role of the texture model of the first surface to be rendered.

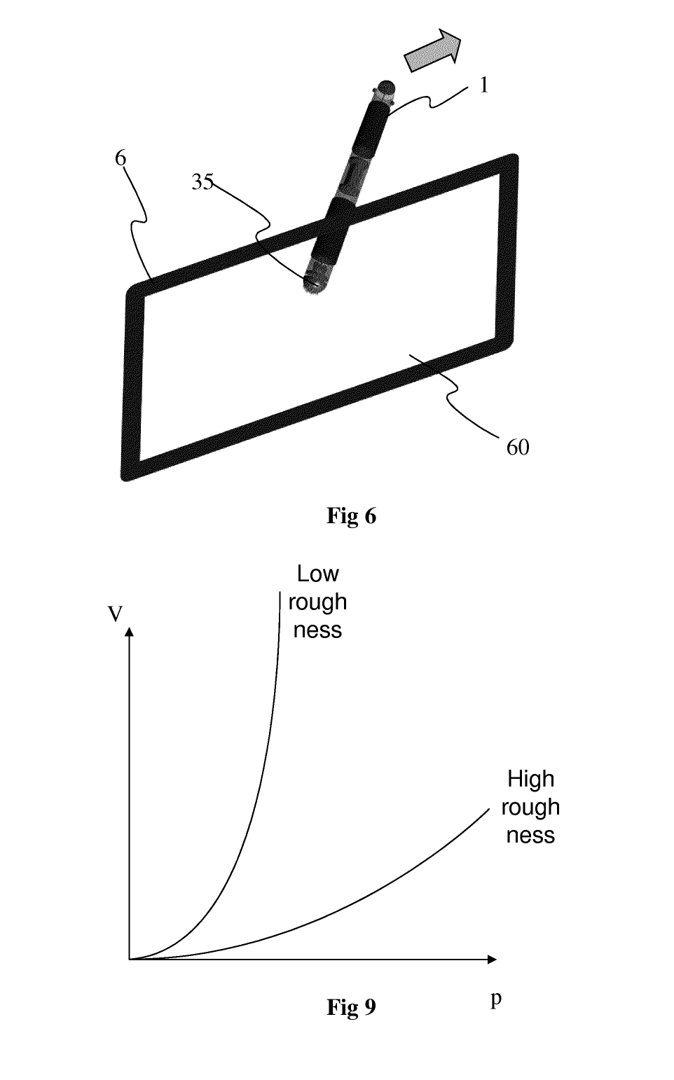

FIG. 6 shows the rendering stage of the information representative of the roughness of the first surface with the use of the device 1, according to an exemplary and non-limiting embodiment of the present principles. The rendering stage is advantageously performed by sliding the device 1 on a second surface 60, for example the screen of a tablet 6, the second surface being different from the first surface. During the rendering stage, the rendering part of the device 1 is directed toward the second surface with the controllable lead 35 in contact with the second surface 60 during the sliding of the device 1 on the second surface 60. During the rendering stage, the user slides the rendering part of the device 1 (advantageously equipped with gradable picots) on the second surface 60. The speed of the device 1 as well as its position on the second surface 60 are tracked by the mean of the tactile capabilities of the tablet 6. According to a variant, the speed of the device is measured by using the speed measuring means integrated in the rendering module. The pressure sensitive surface provided on the rendering module of the device 1 records the current pressure patterns applied by the hand of the user. At each moment a friction measurement may be computed in a similar way than the one described hereinbefore. Then, knowing the friction level of the first surface to render, a closed-loop (as described with regard to FIG. 4) may be used to adapt the roughness level of the lead 35 so that the current level of friction and the desired one, i.e. the instruction corresponding to the acquired information representative of the roughness of the first surface, are as close as possible. The lead roughness is adapted by withdrawing or taking out the picots and several automatic control strategies may be adopted (such as a simple PID controller for instance) to determine the optimal position of the picots.

Let's denote ‘h’ the texture model relating the pressure p and the speed v for the texture of the first surface to be rendered. Two examples of such models are illustrated on FIG. 9. For any couple p and v associated with the first surface we thus have:

v−h(p)=0 Equation 2

During the rendering step, a closed loop, as illustrated on FIG. 4, adapts the roughness of the lead (35) of the device 1 depending on the measured pressure on the pressure-sensitive surface and the measured speed. The goal is to reproduce the texture of the first surface previously modeled by the function h, for example acquired with the capturing process described with regard to FIG. 5, two models of the texture acquired with this process being illustrated on FIG. 9 (low and high roughness). As a non-limiting example, let's consider the specific case where the roughness is adapted by the mean of retractable sticky picots. Let's note l[k], v[k] and p[k] the length of the picots, the measured speed and pressure at step k during the rendering process of the texture of the first surface on the second surface 60. Let's also assume that the roughness of the lead (35) varies with the length of the picots pushed out of the lead (35). According to an exemplary embodiment, one can dynamically adapt the picots length at step k+1 by the mean of a simple proportional controller as follows:

l[k+1]=l[k]+α*(v[k]−h(p[k])) Equation 3

where α is the gain of the controller (possibly negative) empirically set to match the user-specific requirements of the error recovery performances. When the current speed and pressure are compatible with the model (i.e. v[k]−h(p[k])˜0) no corrections are applied, whereas, as soon as a divergence from the model is observed (i.e. 0<<|v[k]−h(p[k])|) a bigger correction is applied.

According to a variant, a more complex controller (PI—Proportional/Integral, PID—Proportional/Integral/Derivative, LQGR—Linear Quadratic Gaussian Regulator) may be also used in a very similar manner to increase the performance of the regulation loop.

According to an exemplary embodiment, the rendering of the roughness of the first surface on the second surface is associated with a visual feedback on the tablet screen 6. In a typical case, one can display a photorealistic model of the texture of the first surface on the tablet to enhance the texture rendering. In a more advanced mode, this model may be even animated by the mean of a physical model (mechanical model computed through a finite element model for instance) coupled with i) the position of the device 1 on the screen recorded by the mean of the tactile capabilities of the tablet 6 and ii) the device lead pressure measured by the device itself through its force-feedback capabilities. In a third mode, pseudo-haptic effects could be also added on the top of the physical model. One could for instance increase the friction feeling by creating an artificial discrepancy between the motion of the device 1 and the associated visual feedback.

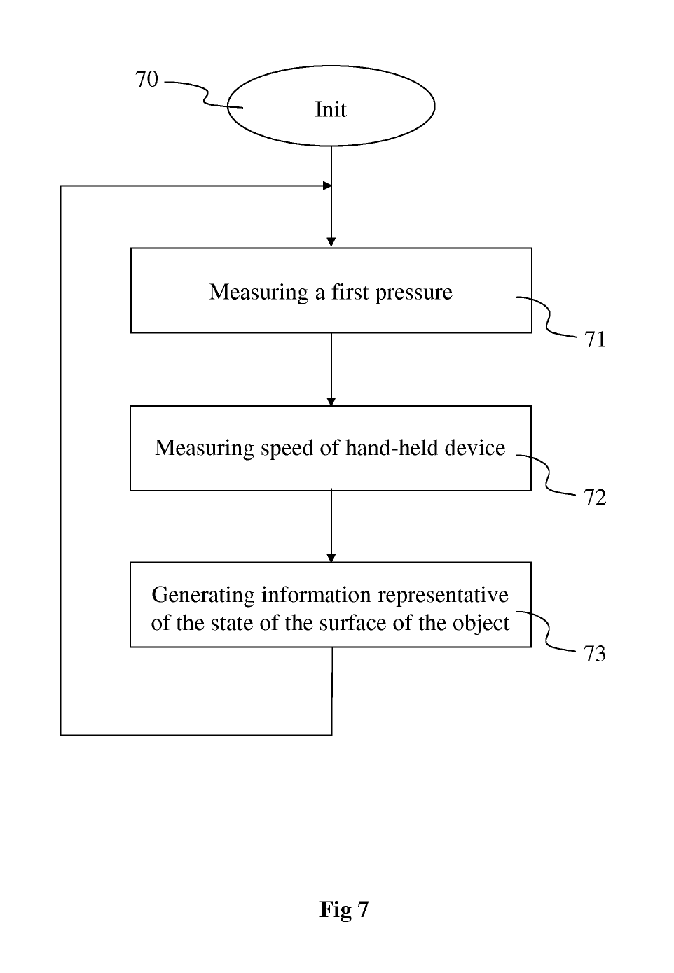

FIG. 7 shows a method of determining information representative of the roughness of a first surface of an object for example with the hand-held device 1, i.e. with the capturing module of the device 1 or with the capturing module as a stand-alone tool, according to an exemplary and non-limiting embodiment of the present principles.

During an initialisation step 70, the different parameters of the device 1, notably the parameters representative of the speed and/or of the pressure applied on the device 1, are updated. The parameters are for example initialized when powering up the device 1 or when capturing the information representative of the roughness of a further first surface.

Then during a step 71, the pressure applied by at least a part of the hand of a user is measured. Different values of the pressure are advantageously regularly acquired along the path formed when sliding the capturing module on the first surface. According to a variant, the pressure pattern of the part of the hand grasping the device 1 is also captured.

Then during a step 72, values of the speed of the device 1 are regularly measured along the path formed when sliding the capturing module on the first surface. The measures of the speed are advantageously performed at a same rate as the measures of pressure and synchronously. According to a variant, the measures of the speed are performed at a different rate and/or asynchronously. According to this variant, additional speed values may be obtained by interpolating the measured values to recover a synchronisation with the measured pressure values. According to another example, the mean pressure value over a time may be computed as well as a mean speed value over the same time interval, the means values being then used to determine the information representative of roughness.

Then during a step 73, information representative of roughness of the first surface is generated as a function of the measured pressures and the measured speeds along the path corresponding to the sliding contact of the device 1 on the first surface.

According to an optional variant, the steps of measuring the pressures and the speeds are performed for different sliding paths over the first surface, for example two orthogonal sliding paths.

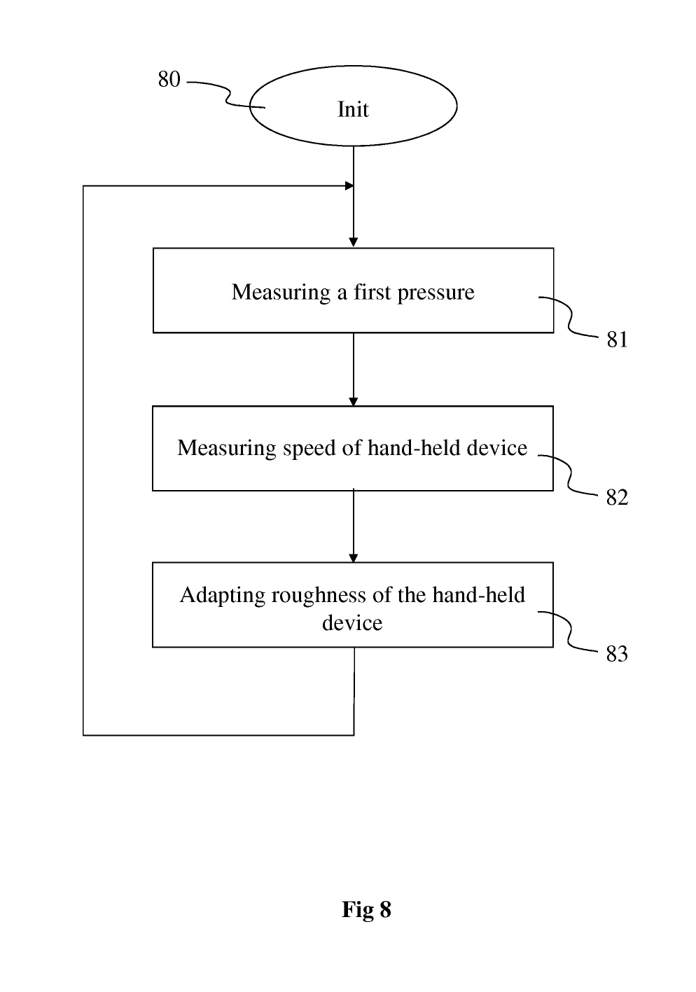

FIG. 8 shows a method of rendering information representative of roughness of a first surface of an object for example with the hand-held device 1, i.e. with the rendering module of the device 1 or with the rendering module as a stand-alone tool, according to an exemplary and non-limiting embodiment of the present principles.

During an initialisation step 80, the different parameters of the device 1, notably the parameters representative of the speed and/or of the pressure applied on the device 1, are updated. The parameters are for example initialized when powering up the device 1 or when rendering the information representative of the roughness of a further first surface.

Then during a step 81, the pressure applied by at least a part of the hand of a user is measured when sliding the device 1 on a second surface different from the first surface. Different values of the pressure are advantageously regularly acquired along the path formed when sliding the capturing module on the second surface. According to a variant, the pressure pattern of the part of the hand grasping the device 1 is also captured.

Then during a step 82, values of the speed of the device 1 are regularly measured along the path formed when sliding the device 1 on the second surface. The measures of the speed are advantageously performed at a same rate as the measures of pressure and synchronously. According to a variant, the measures of the speed are performed at a different rate and/or asynchronously. According to this variant, additional speed values may be obtained by interpolating the measured values to recover a synchronisation with the measured pressure values. According to another example, the mean pressure value over a time may be computed as well as a mean speed value over the same time interval, the means values being then used to determine the information representative of roughness.

Then during a step 83, roughness of the part of the device 1 in contact with the second surface during the sliding motion of the device 1 over the second surface is adapted as a function of the measures of pressure and speed performed at steps 81 and 82 and as a function of the information representative of the roughness first surface to be rendered, as described for example with regard to FIG. 6. The information representative of the roughness first surface to be rendered corresponds for example to the information captured with the capturing module of the device 1, as described with regard to FIGS. 4, 5 and/or 7. According to another example, the information representative of the roughness first surface to be rendered corresponds to an information acquired differently and received by the rendering module, for example via a wireless connection, this information being for example stored in a library of different information of roughness associated with different types of first surfaces.

Naturally, the present disclosure is not limited to the embodiments previously described.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A device configured to determine information representative of roughness of a surface of an object, comprising:
a first pressure sensor measuring a first pressure applied by at least a part of a hand on said device,
a sticky part configured to be in contact with said surface,
a speed measuring interface measuring a speed of said device, said information representative of roughness being a function of said first pressure and said speed.

2. The device according to claim 1, further comprising a second pressure sensor measuring a second pressure applied on said sticky part.

3. The device according to claim 1, further comprising a microphone acquiring information representative of a sound made by said device when moving on said surface.

4. The device according to claim 1, further comprising a thermal sensor measuring information representative of thermal properties of said surface.

5. The device according to claim 1, further comprising a memory storing information representative of said first pressure and information representative of said speed.

6. The device according to claim 1, further comprising a communication interface configured to transmit information representative of said first pressure and information representative of said speed.

7. The device according to claim 1, wherein said device is a hand-held device, the first pressure sensor measuring the first pressure being arranged on a part of a body of said device.

8. A device configured to render information representative of roughness of a first surface of an object, comprising:
a pressure sensor measuring a first pressure applied by at least a part of a hand on said device,
a speed measuring interface measuring a speed of said device,
an adaptor adapting roughness of a part of said device configured to be in contact with a second surface different from the first surface, the roughness of said part of the device being adapted according to the measured first pressure, the measured speed and according to information representative of the feel of the first surface to be rendered.

9. The device according to claim 8, further comprising a vibrator configured to render vibratory effect.

10. The device according to claim 8, further comprising a thermal actuator rendering thermal properties of said first surface.

11. The device according to claim 8, further comprising an audio speaker rendering at least a sound.

12. The device according to claim 8, wherein said device is a hand-held device, the pressure sensor being arranged on a part of a body of said device.

13. A haptic device comprising said device according to claim 1.

14. A method of determining information representative of roughness of a surface of an object with a hand-held device, comprising:
measuring a pressure applied by at least a part of a hand on said hand-held device during a motion of said hand-held device on said surface, said hand-held device being in contact with said surface during the motion,
measuring a speed of said hand-held device during said motion of said hand-held device on said surface,
generating said information representative of roughness of said surface according to the measured first pressure and the measured speed.

15. A method of rendering information representative of roughness of a first surface of an object with a hand-held device, comprising:
measuring a first pressure applied by at least a part of a hand on said hand-held device during a motion of said hand-held device on a second surface different from the first surface, said hand-held device being in contact with said second surface during the motion,
measuring a speed of said hand-held device during said motion of said hand-held device on said second surface,
adapting roughness of said part of said hand-held device in contact with said second surface, the roughness of said part of the device being adapted according to the measured first pressure, the measured speed and according to information representative of the feel of the first surface to be rendered.

16. The haptic device according to claim 13 further comprising said device according to claim 8.
